(19) United States
(12) Patent Application Publication
(10) Pub. No.: US 2009/0210343 A1
(43) Pub. Date: Aug. 20, 2009

(54) PAYMENT SYSTEM

(76) Inventor: Desmond Griffin, Vancouver (CA)

Correspondence Address: SONNABENDLAW, 600 PROSPECT AVE, BROOKLYN, NY, 11215, US

(21) Appl. No.: 12/032,666

(22) Filed: Feb. 16, 2008

(51) Int. Cl. G06Q 20/00

(52) U.S. Cl. 705/40

(57) ABSTRACT

A method for processing a payment from a payor for an asset and notifying an operator of said asset of said payment, is disclosed comprising the steps of: receiving a communication from a payer using a communication device via a communication channel, said communication comprising a request to make payment associated with an asset; determining an identifier of said payer; receiving from said payor an identifier for said asset; receiving from said payor a payment amount; determining a payor account from which to process said payment; determining a payee associated with said asset; determining a payee account into which to process said payment; processing said payment from said payor account to said payee account; determining an operator associated with said asset; and notifying said operator via a second communication channel of said payment.

### BACKGROUND OF THE INVENTION

1. Field of the Invention

The present invention relates generally to the field of business transaction methods and systems, and more particularly to mobile payment systems.

2. Background of the Related Art

For the traveler, whether it be for a vacation, business trip, or commuting back and forth to a place of work, there is the common necessity to pay for taxi rides and other services on the way to a destination. Typically, the only means for a traveler or commuter to pay for such services is by presenting to a vendor of a form of tender, e.g., cash, credit card, or check.

However, payment in the form of tender poses several inconveniences for traveling people. For example, traveling people very often find themselves in a situation where they do not have the required amount of cash to pay for a service. In addition, credit cards and checks are very often not accepted by vendors. Furthermore, where credit cards or checks are accepted, it frequently occurs that travelers do not have these available at the time of payment. Lastly, many travelers are wary of using cash, credit cards, or checks due to safety concerns.

Accordingly, there remains a need for a simple non-tender payment system which is particularly suitable for on-the-spot payment transactions for travelers and commuters.

### SUMMARY OF THE INVENTION

The present invention is directed to a non-tender mobile payment system and method with particular benefit to the traveler or commuter as well as vendors of services.

As a result of the present invention, a traveling person may pay taxi fares and other fees in a simple and convenient manner without the need for cash, credit cards, or checks. Payments are made in connection with one or more assets. The present invention transmits payment confirmation information to one or more operators associated with the asset for which payment has been processed, such operators having previously registered an association with such asset.

While the instant invention is described in connection with taxi fare payments, one of ordinary skill in the art will readily understand that the present invention may be equally applicable to any situation in which customers pay for services rendered, products purchased, or assets utilized.

Certain embodiments of the present invention include a method for processing a payment from a payor for an asset and notifying an operator of the asset of the payment. The method may include the following steps: receiving a communication from a payor using a communication device via a communication channel, the communication comprising a request to make payment associated with an asset; determining an identifier of (or for) the payor, that is, an identifier capable of distinguishing the payor from all other payors; receiving from the payor an identifier for the asset, that is, an identifier capable of distinguishing the asset from all other assets; receiving from the payor a payment amount; determining a payor account from which to process the payment; determining a payee associated with the asset; determining a payee account into which to process the payment; processing the payment from the payor account to the payee account; determining an operator associated with the asset; and notifying the operator via a second communication channel of the payment.

In processing the payment, certain embodiments of the present invention may determine that the payment request cannot be completed due to a condition related to the payor, for example, where the payor is using an invalid credit or debit card, where the payor's bank or credit card provider declines the transaction, or where the payor has insufficient funds in a relevant account to complete the transaction. In such instances, the method of the present invention may include the steps of denying the payment request and/or informing an operator associated with the asset in question that the transaction has been denied and payment therefore has not been made.

In the foregoing embodiments, the step of determining an identifier of the payor may comprise the steps of identifying a unique parameter from the communication channel and using the unique parameter as the identifier of the payor. A parameter of the communication channel may be any attribute knowable from the medium used to convey the information from the sender (e.g., the payor or operator, as described below) to a receiver (e.g., the system implementing the method described herein). Parameters may include, for example, an International Mobile Subscriber Identity number, a Temporary Mobile Subscriber Identity, or a cellular telephone number for the sender's communication device.

In certain embodiments of the present invention, the sender of information may be using a cellular telephone and the communication channel would be a cellular communication channel. As used herein, “cellular telephone” may include similar technologies now known or hereafter implemented.

Certain embodiments of the present invention may include the further steps of retrieving from the payor a payor password; retrieving a previously stored payor password associated with the unique parameter; comparing the payor password and the previously stored payor password; and denying the request to make payment if the payor password and the previously stored payor password do not match.

Still other embodiments of the present invention may include steps for creating a payor's account, for example, obtaining an identifier for the payor, for example, by obtaining a unique parameter from the communication channel used by the payor as previously described and using the unique parameter as the identifier of the payor. This identifier may then be stored in a database for later use in identifying the payor upon his or her making a request to process a payment, as described above. The present invention may also request and receive a payor password for the payor and store the payor password in the aforementioned database for use in confirming the identity or authority of the payor upon his or her making a request to process a payment.

These and other aspects of the subject invention will become more readily apparent to those having ordinary skill in the art from the following detailed description of the invention taken in conjunction with the drawings described herein.

### BRIEF DESCRIPTION OF THE DRAWINGS

So that those having ordinary skill in the art to which the subject invention pertains will more readily understand how to make and use the subject invention, preferred embodiments thereof will be described in detail herein with reference to the drawings.

FIG. 1 is a flowchart of a preferred embodiment of the present invention depicting the steps for processing a payment request and payment transaction.

FIG. 2 is a flowchart of a preferred embodiment of the present invention depicting the steps for confirming payment for an asset to an operator associated with such asset.

FIG. 3 is a flowchart of a preferred embodiment of the present invention depicting the steps for associating an operator with an asset

FIG. 4 is a database description of a preferred embodiment of the present invention.

### DETAILED DESCRIPTION OF THE PREFERRED EMBODIMENTS

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

As used herein, program modules, software modules and like references indicate logical program units and do not necessarily indicate structurally discreet structures. The modules disclosed herein may be combined and/or further separated without departing from the inventive aspects of the present invention. Furthermore, the invention may be practiced in distributed computing environments wherein modules reside and/or are executed on several processing devices. In such a distributed computing environment, program modules may be located in both local and remote memory storage devices.

It will be readily understood that references to “system” and “the system” as used herein in connection with methods or processes are meant to refer to systems and/or products executing or embodying the methods described.

Embodiments of the invention disclosed herein may include a database of vendors (the providers or payees) and consumers (the payors or purchasers). The database may contain a personalized account for each vendor and consumer. Each of the vendors and consumers may each independently be either individuals, a group of individuals, or a place of business, such as a corporation or sole proprietorship.

A personalized account for each vendor and consumer may be established by a registration process by which a vendor or consumer provides specific information for the purpose of establishing an account. The registration-specific information may include, for example, a cell phone number, a personal identification number (PIN), and information on the consumer's payment source from which funds may be withdrawn and ultimately transferred to a vendor personalized account. The payment source may be any type of account from which funds may be electronically transferred to a vendor account. Some suitable types of payment sources include, for example, credit card accounts, debit accounts, bank accounts and other pre-paid accounts.

The personalized accounts may be remotely accessed by a vendor or consumer. Typically, a personalized account is accessible only by the account holder or holders registered with the account. A vendor or consumer may remotely access a personalized account by use of any device capable of remote access to an electronic database holding personal accounts. Preferably, the device for remote accessing is a cellular phone (mobile phone) or related wireless communication device. Some examples of other suitable wireless communication devices include laptop computers, text messaging devices (e.g., devices that use short message service (SMS)), and personal digital assistants (PDAs), also known as pocket or palmtop computers. Some examples of PDAs include the BlackBerry, Palm Treo, and Apple iPhone. However, the device for remote accessing is not restricted to a wireless device according to the present invention. If desired, remote accessing may also be achieved by use of, for example, a fixed wireless or landline device.

The system may include means, upon access of a consumer to a consumer personalized account, for transferring funds from a consumer source account to a vendor for charges incurred by the consumer in for services rendered or products proved by an operator of the vendor, such services or products being provided in connection with particular asset. By way of example, a taxi driver (the operator) may drive a taxi (the asset) and provide taxi services to a rider (the consumer) on behalf of a taxi company (the vendor). The rider may initiate payment by communicating to the system of the present invention a consumer identifier, a taxi identifier, and a payment amount.

In order to fully process payment requests received from consumers, embodiments of the present invention may associate certain assets with certain vendors. For example, a taxi company (the vendor) may own several taxis (the assets). The system of the present invention may allow the vendor to identify one or more taxis as being owned by the vendor. Thereafter, when processing payments from consumers for use of such taxis, the system of the present invention may credit the proper vendor the proceeds of such payment. In addition, embodiments of the present invention may permit vendors to specify one or more accounts to receive the proceeds of payments.

In certain embodiments, vendors may be treated as each having only a single asset, in which case asset identifiers may be unused and all transactions processed with reference only to vendor identifiers. Similarly, in embodiments where both vendor identifiers and asset identifiers are use, certain vendors may have only single assets. In such instances, embodiments of the present invention may disregard asset identifiers for such vendors, utilizing only such vendors' vendor identifiers for purposes of processing transactions.

Means for transferring funds are well known in the art. If desired, the transfer of funds may include other additional fees, including percent fees, fixed fees, or fees that change or adjust according to a certain threshold value. The fees may be automatically applied or applied on request. They may be applied to any designated party registered in the database, including, for example, a vendor individual, vendor business, or the payment system provider. The transfer of funds may also include an automatic or requested rebate based on any desired set of criteria.

In certain embodiments of the present invention, an operator may associate herself with a particular asset for purposes of receiving payment confirmation for payments made by consumers in connection with such asset, among other possible purposes. Continuing the previous example, upon beginning her shift, the driver may associate herself with a particular taxi (the asset) by notifying the system of the present invention of such association, e.g., by communicating to the system, by cell phone or other means, an operator identifier and an asset identifier. The system of the present invention may then send a confirmation message to the driver confirming that she has been associated with taxi she identified. Thereafter, upon the subsequent processing fare payments from riders of the taxi, the system of the present invention may notify the operator, for example by cell phone text message, of receipt of payment.

In the foregoing embodiments, the system of the present invention may determine operator identifiers and/or consumer identifiers from the communication channel of the operator and/or consumer, for example, by means of caller id data obtained from cell phones used by the operator and/or consumer to communicate with the system of the present invention. Furthermore, in each of the foregoing embodiments, the system of the present invention may require entry of passwords, personal identification numbers or the like to protect against unauthorized uses of the system. Communications may be encrypted, as will be readily understood by those of ordinary skill in the art.

In another aspect, the invention is directed to a payment method using the payment system described above. After a vendor or consumer registers with the payment system provider to establish a personalized account, the vendor or consumer may remotely access the account for any number of reasons including to transfer funds, verify funds transferred, obtain a transactional history, change personal information, settings, and preferences, and the like. In order for a vendor or consumer to access a personalized account, the vendor or consumer must provide some form of account holder verification. In one embodiment, the verification process is automatic and/or instantaneous upon remote access without further input from the vendor or consumer. Such an automatic verification process may be based, for example, on an electronic recognition process between the calling device and the mobile payment system. In another embodiment, the verification process requires inputted information from the vendor or consumer before access to the personal account is allowed.

Asset identifier information may be known ahead of time by the consumer, thereby allowing asset information to be entered into a consumer's personalized account ahead of an expected transaction. Asset information may also be electronically readable from an asset device to the remote accessing device of the consumer, thereby allowing for the automatic transmission of a asset's information to system of the present invention. For example, the consumer's remote accessing device may be equipped with a smayning component capable of reading and transmitting information obtained from a bar code or other type of smaynable code for an asset, or such information may be transmitted form an asset to a consumer's device via radio frequency identification or other similar means.

The payment method may include a means for a vendor to confirm that transfer of funds of a certain amount to his or her account has been completed. The payment method may also include a means for a consumer to confirm that a transfer of funds from his or her account to a particular payee account has been completed. The confirmation may be provided by any suitable means, including, for example, as an automatic text message, a phone call, a caller ID notation, an email, or a message or notation which is stored in the vendor's or consumer's personalized account for future access.

The payment system and method of the invention may include any additional amenities and/or auxiliary components that would commonly be used or practiced by people engaged in electronic business transactions. For example, the payment system may include means for setting an automatic payment schedule where a specified amount of funds is set to be automatically transferred at specific times over a specified number of intervals (e.g., on a weekly or monthly basis). The payment system may also include an advanced payment scheme where one or more transactions are pre-paid for. The payment system may also include that one or more transactions are paid for at a specific time after services or goods are rendered.

The payment system may also include additional services that function in a complimentary manner to the needs of the vendors or consumers using the payment service. For example, the payment service described herein may include means for vendors to find consumers and consumers to find vendors. Such a service could, for example, help taxi driver operators locate a consumer in need of a ride. The additional service may also include, for example, providing operators or consumers with directions, departure times, information on local restaurants, show times, or news alerts.

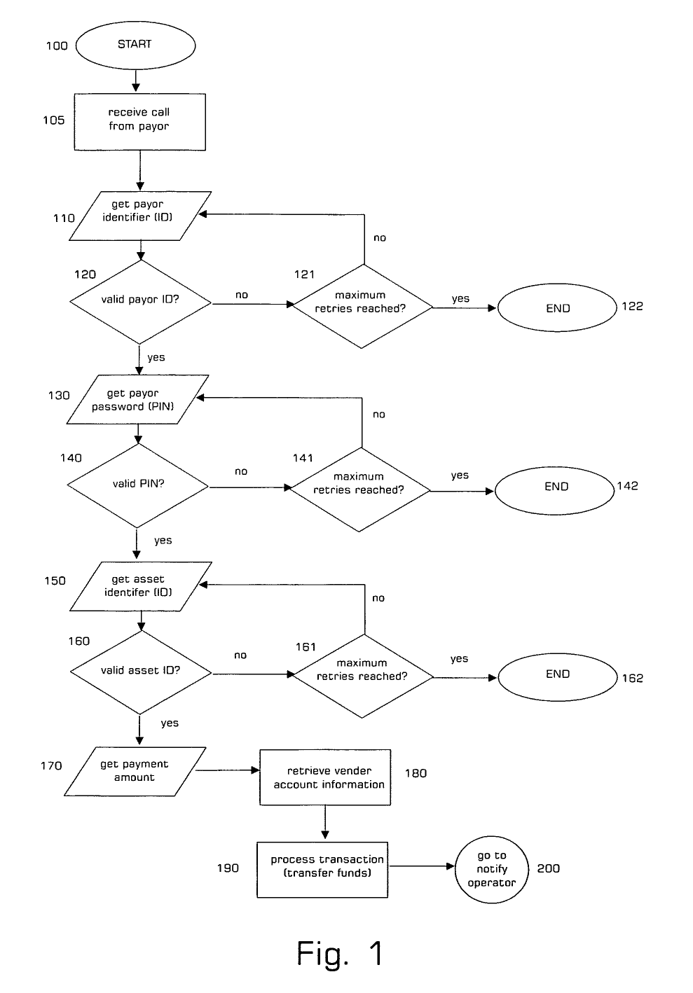

Now, with reference to the accompanying figures, FIG. 1 is a flowchart of a preferred embodiment of the present invention depicting the steps for processing a payment request. As shown, processing begins in step 105 by receiving a call (or other initiating communication) from a customer requesting that a payment be made. The process then receives from the customer a payor identifier in step 110. In step 120, the process determines whether the ID received in step 110 is valid. This may be accomplished through database lookup as will be readily understood by those of skill in the art. If in step 120 the system determines that the payor ID is invalid, the customer may be permitted via step 121 to re-enter the ID until a maximum number of retries is reached, at which point the system may terminate processing in step 122. Prior to termination of processing in step 122, the system may generate one or more error messages, which may be transmitted to the customer and/or logged, as will be readily understood by those of skill in the art.

Upon validating a payor ID in step 120, processing may continue to step 130, wherein the system receives from the payor a password or PIN. The system may prompt the payor for his or her PIN in connection with step 130. In step 140, the process determines whether the PIN received in step 130 is valid. As previously discussed, this may be accomplished through database lookup. If in step 140 the system determines that the PIN is invalid, the payor may be permitted via step 141 to re-enter PIN until a maximum number of retries is reached, at which point the system may terminate processing in step 142. Prior to termination of processing in step 142, the system may generate one or more error messages, which may be transmitted to the payor and/or logged, as will be readily understood by those of skill in the art.

After validating a payor PIN in step 140, processing may continue to step 150, wherein the system receives from the payor an asset identifier, for example, a taxi ID number. The system may prompt the payor for the asset identifier in step 150. As with the previously described steps, processing may continue to a validation step in step 160, possibly utilizing a database lookup, with appropriate retries for invalid asset ID's in step 161 and termination upon exceeding the maximum allowed retries in step 162. Prior to termination of processing in step 162, the system may generate one or more error messages, which may be transmitted to the customer and/or logged, as will be readily understood by those of skill in the art.

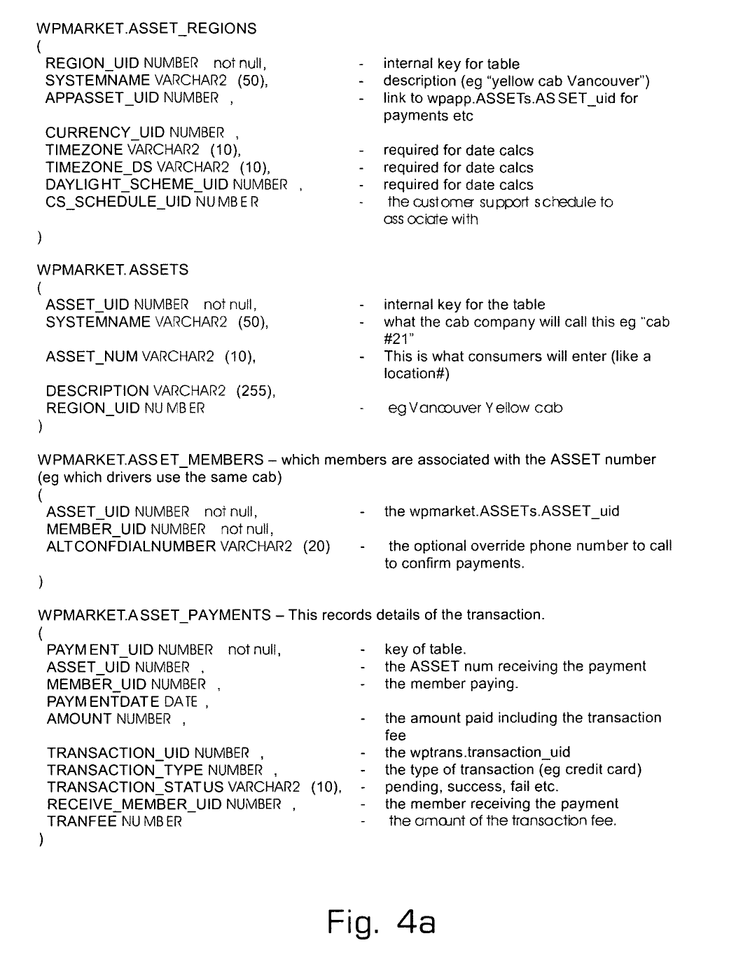

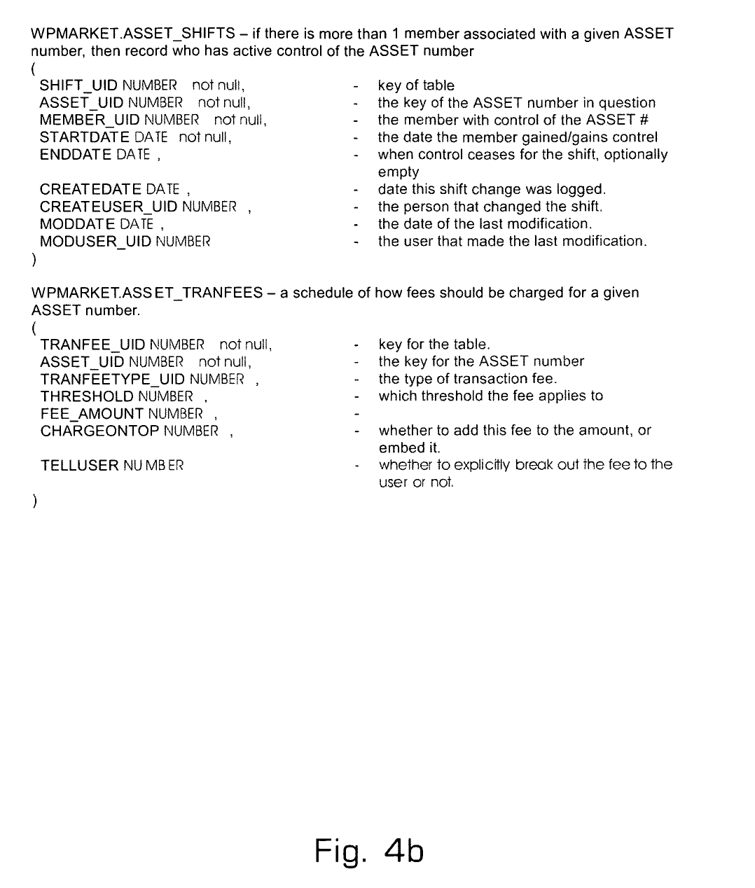

After validating the asset ID, processing may continue to step 170, wherein the system receives from a payor a payment amount. Upon receiving the payment amount in step 170, the system may validate the amount by confirming that it is greater than a minimum amount and/or less than a maximum amount, for example. Thereafter, the process continues to step 180, wherein the system retrieves vendor account information such as account name and number of a bank or merchant account to receive the payment, as well as any payment adjustments such as the addition of transaction fees, for example. This may be accomplished through a database lookup, for example to table WPMARKET.ASSET_TRANFEES in FIG. 4, as will be readily understood. Processing may then continue to step 190, wherein the payment transaction is processed in accordance with well understood payment transaction processing methodologies.

After validating the asset ID, processing may continue to step 470, wherein the system determines whether the operator (referred to as “member” in table WPMARKET.ASSET_MEMBERS of FIG. 4) is valid for the asset identified, that is, whether or not the operator is authorized to be associated with the asset. This may be accomplished through a database lookup to the WPMARKET.ASSET_MEMBERS table of FIG. 4, for example, as will be readily understood. In connection with step 470, the system executing the method may include a step of creating a database of valid operator ID's for each asset for which payments are processed by the system. If in step 470 the operator is not validly associated with the asset, the system may terminate processing in step 490. Prior to termination in step 490, the system may generate one or more error messages, which may be transmitted to the vendor and/or logged, as will be readily understood by those of skill in the art.

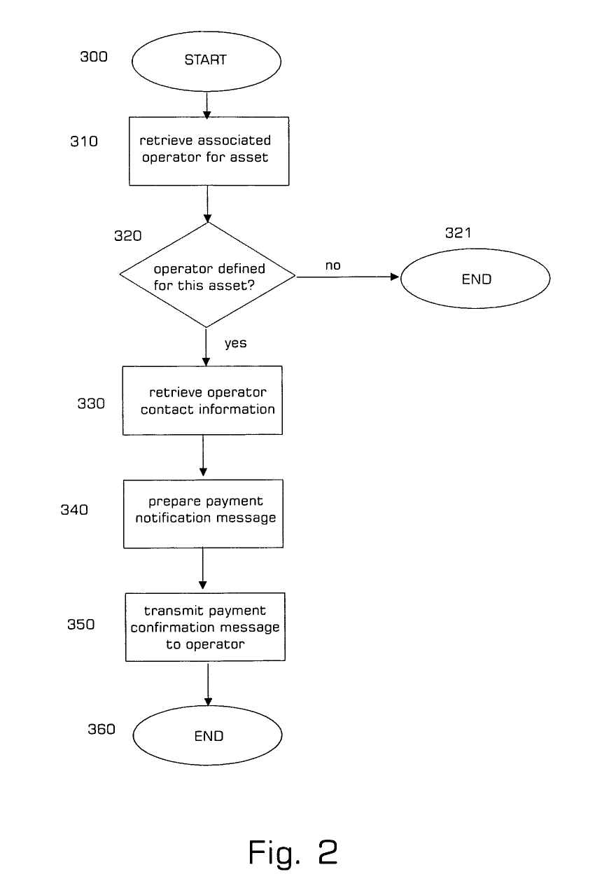

In certain embodiments, after processing a payment as just described, the system may notify an operator associated with the asset associated with the payment regarding the status of the payment, e.g., whether or not the payment was processed successfully, the amount of payment and like information. FIG. 2 depicts the steps of a preferred embodiment executing this functionality. Processing begins by retrieving in step 310 an operator associated with the asset for which payment was processed (whether or not successfully or unsuccessfully processed). As previously discussed, this may be accomplished through database lookup. If in step 320 the system determines that no operator is defined for the asset, then processing concludes in step 321. Prior to termination of processing in step 321, the system may generate one or more error messages, which may be transmitted to the vendor associated with the asset and/or logged, as will be readily understood by those of skill in the art.

Upon confirmation of an operator associated with the asset, processing may continue to step 330, wherein the system may retrieve contact information for the operator, for example, a cell phone number to which a text message is to be transmitted. The system then may prepare in step 340 an appropriate message concerning the payment and transmit that message to the operator in step 350 before terminating in step 360.

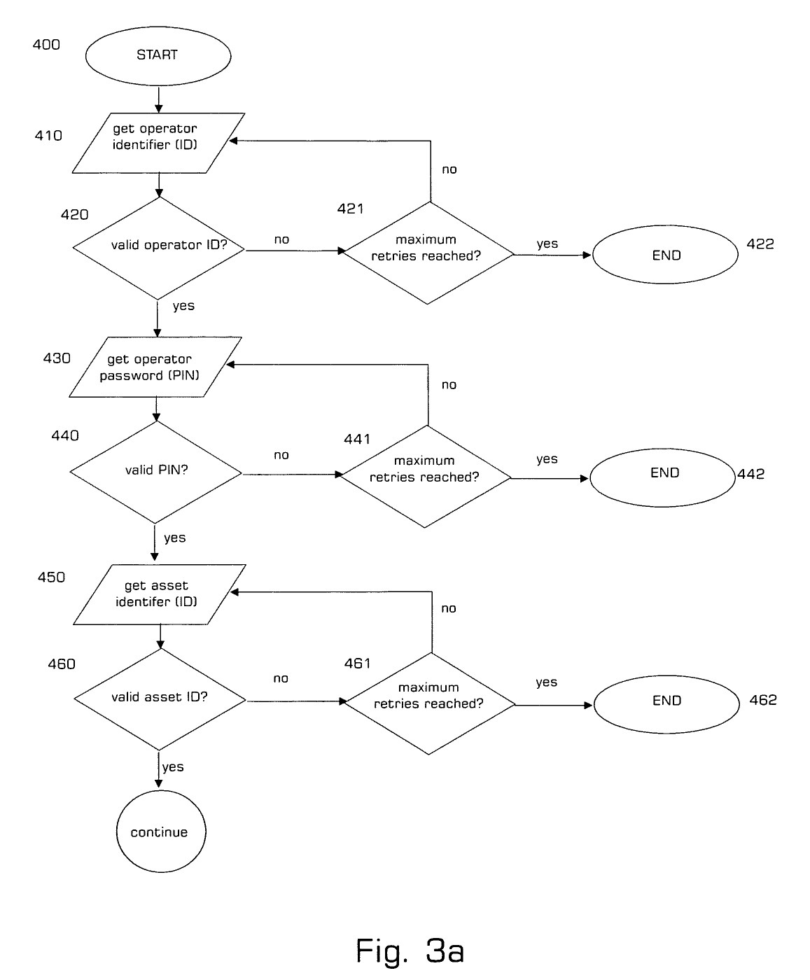

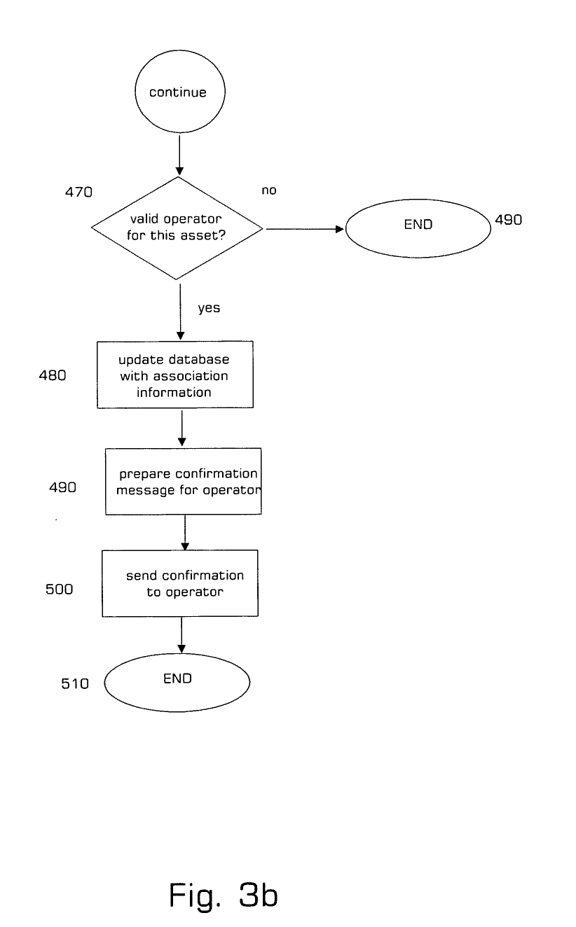

FIG. 3 is a flowchart of a preferred embodiment of the present invention depicting the steps for associating an operator with an asset. Processing begins in step 405, wherein the system receives a call (or other initiating communication) from an operator wishing to be associated with an asset. Upon receiving the call, processing may continue to step 410 wherein the system receives from the operator an operator identifier In step 420, the process determines whether the ID received in step 410 is valid. This may be accomplished through database lookup as will be readily understood by those of skill in the art. If in step 420 the system determines that the operator ID is invalid, the operator may be permitted via step 421 to re-enter the ID until a maximum number of retries is reached, at which point the system may terminate processing in step 422. Prior to termination of processing in step 422, the system may generate one or more error messages, which may be transmitted to the operator and/or logged, as will be readily understood by those of skill in the art.

Upon validating a operator ID in step 420, processing may continue to step 430, wherein the system receives from the operator a password or PIN as previously discussed. The system may prompt the operator for his or her password in connection with step 430. In step 440, the process determines whether the PIN received in step 430 is valid. As previously discussed, this may be accomplished through database lookup. If in step 440 the system determines that the PIN is invalid, the customer may be permitted via step 441 to re-enter PIN until a maximum number of retries is reached, at which point the system may terminate processing in step 442. Prior to termination of processing in step 442, the system may generate one or more error messages, which may be transmitted to the customer and/or logged, as will be readily understood by those of skill in the art.

After validating a operator PIN in step 440, processing may continue to step 450, wherein the system receives from the operator an asset identifier, for example, a taxi ID number. The system may prompt the operator for the asset identifier in step 450. As with the previously described steps, processing may continue to a validation step in step 460, possibly utilizing a database lookup, with appropriate retries for invalid asset ID's in step 461 and termination upon exceeding the maximum allowed retries in step 462. Prior to termination of processing in step 462, the system may generate one or more error messages, which may be transmitted to the vendor and/or logged, as will be readily understood by those of skill in the art.

If in step 440 the operator is validated for the asset, the system may updated a database with association information (maintained, for example, in table WPMARKET.ASSET_SHIFTS of FIG. 4), including for example, the ID of the operator now associated with the asset. The system in step 440 may also remove any previous associations for the asset. It will be readily understood that the association of a new operator with an asset, and the removal of an existing association between that asset and a prior operator, may be considered changes of “shifts,” as in taxi driver shifts.

After the validation an related database updates, processing may continue to step 490 wherein the system may prepare an appropriate confirmation message for the operator, which may be transmitted to the operator in step 490. The confirmation message may be transmitted to the operator immediately in step 490, e.g., via audio confirmation as part of the call initiated by the operator in step 405. Alternatively or additionally, the confirmation message may be sent to the operator separate and apart from the call initiated by the operator in step 405, for example via text message or some other means. The system may determine an appropriate communication means and/or address (e.g., device address, phone number, email address or the like) from information stored in a database maintained by the system. In this regard, systems executing the method may include a step of creating a database of operator information, including communication related information.

While particular embodiments of the present invention have been shown and described, it will be apparent to those skilled in the pertinent art that changes and modifications may be made without departing from the invention in its broader aspects.

What is claimed is:

1. A method for processing a payment from a payor for an asset and notifying an operator of said asset of said payment, comprising the steps of:
receiving a communication from a payer using a communication device via a communication channel, said communication comprising a request to make payment associated with an asset;
determining an identifier of said payer;
receiving from said payor an identifier for said asset;
receiving from said payor a payment amount;
determining a payor account from which to process said payment;
determining a payee associated with said asset;
determining a payee account into which to process said payment;
processing said payment from said payor account to said payee account;
determining an operator associated with said asset; and
notifying said operator via a second communication channel of said payment.

2. The method of claim 1, wherein said step of determining an identifier of said payer comprises the steps of identifying a unique parameter from said communication channel and using said unique parameter as said identifier of said payer.

3. The method of claim 2 wherein said communication channel is a cellular telephone communication channel and said unique parameter is selected from the group comprising: (i) an International Mobile Subscriber Identity number of said communication device, (ii) a Temporary Mobile Subscriber Identity, and (iii) a cellular telephone number of said communication device.

4. The method of claim 2 further comprising the steps of:
retrieving from said payor a payor password;
retrieving a previously stored payor password associated with said unique parameter;
comparing said payor password and said previously stored payor password; and
denying said request to make payment if said payor password and said previously stored payor password do not match.

5. The method of claim 3 further comprising the steps of:
retrieving from said payor a payor password;
retrieving a previously stored payor password associated with said unique parameter;
comparing said payor password and said previously stored payor password; and
denying said request to make payment if said payor password and said previously stored payor password do not match.

6. A method for processing a payment from a payor for an asset and notifying an operator of said asset of said payment, comprising the steps of:
receiving a communication from an operator using a first communication device via a first communication channel, said communication comprising a request to be associated with an asset;
determining an identifier of said operator;
processing said request to be associated with said asset, said processing comprising one of accepting said request and denying said request;
receiving a communication from a payer using a second communication device via a second communication channel, said communication comprising a request to make payment associated with said asset;
determining an identifier of said payer;
receiving from said payor an identifier for said asset;
receiving from said payor a payment amount;
determining a payor account from which to process said payment;
determining a payee associated with said asset;
determining a payee account into which to process said payment;
processing said payment from said payor account to said payee account; and
notifying said operator via a communication channel other than said second communication channel of said payment.

7. The method of claim 6, wherein said step of determining an identifier of said operator comprises the steps of identifying a unique parameter from said first communication channel and using said unique parameter as said identifier of said operator.

8. The method of claim 7 wherein said second communication channel is a cellular telephone communication channel and said unique parameter is selected from the group comprising: (i) an International Mobile Subscriber Identity number of said communication device, (ii) a Temporary Mobile Subscriber Identity, and (iii) a cellular telephone number of said communication device.

9. The method of claim 7 further comprising the steps of:
retrieving from said operator an operator password;
retrieving a previously stored operator password associated with said unique parameter;
comparing said operator password and said previously stored operator password; and
denying said request to make payment if said operator password and said previously stored operator password do not match.

10. The method of claim 8 further comprising the steps of:
retrieving from said operator an operator password;
retrieving a previously stored operator password associated with said unique parameter;
comparing said operator password and said previously stored operator password; and
denying said request to make payment if said operator password and said previously stored operator password do not match.

11. The method of claim 6, wherein said step of determining an identifier of said payor comprises the steps of identifying a unique parameter from said second communication channel and using said unique parameter as said identifier of said payor.

12. The method of claim 11 wherein said second communication channel is a cellular telephone communication channel and said unique parameter is selected from the group comprising: (i) an International Mobile Subscriber Identity number of said communication device, (ii) a Temporary Mobile Subscriber Identity, and (iii) a cellular telephone number of said communication device.

13. The method of claim 11 further comprising the steps of:
retrieving from said payor a payor password;
retrieving a previously stored payor password associated with said unique parameter;
comparing said payor password and said previously stored payor password; and
denying said request to make payment if said payor password and said previously stored payor password do not match.

14. The method of claim 12 further comprising the steps of:
retrieving from said payor a payor password;
retrieving a previously stored payor password associated with said unique parameter;
comparing said payor password and said previously stored payor password; and
denying said request to make payment if said payor password and said previously stored payor password do not match.

15. The method of claim 6 wherein said step of processing said request to be associated with said asset further comprises the steps of:
retrieving a list of valid operator identifiers for said asset;
determining if said list of valid operator identifiers for said asset includes said operator identifier; and
denying said request where said list does not include said operator identifier and accepting said request where said list does include said operator identifier.

16. The method of claim 15, wherein said step of determining an identifier of said operator comprises the steps of identifying a unique parameter from said first communication channel and using said unique parameter as said identifier of said operator.

17. The method of claim 16 wherein said second communication channel is a cellular telephone communication channel and said unique parameter is selected from the group comprising: (i) an International Mobile Subscriber Identity number of said communication device, (ii) a Temporary Mobile Subscriber Identity, and (iii) a cellular telephone number of said communication device.

18. A method for processing a payment from a payor for an asset and notifying an operator of said asset of said payment, comprising the steps of:
receiving a communication from an operator using a first communication device via a first communication channel, said communication comprising a request to be associated with an asset;
determining an identifier of said operator, said identifier of said operator comprising a unique parameter from said first communication channel;
processing said request to be associated with said asset, said processing comprising one of accepting said request and denying said request;
receiving a communication from a payer using a second communication device via a second communication channel, said communication from said payer comprising a request to make payment associated with an asset;
determining an identifier of said payer, said identifier of said payor comprising a unique parameter from said second communication channel;
receiving from said payor an identifier for said asset;
receiving from said payor a payment amount;
determining a payor account from which to process said payment;
determining a payee associated with said asset;
determining a payee account into which to process said payment;
processing said payment from said payor account to said payee account;
determining an operator associated with said asset; and
notifying said operator via a communication channel other than said second communication channel of said payment.

19. The method of claim 18, wherein each of said first and second communication channels is a cellular telephone communication channel and each of said unique parameters is selected from the group comprising: (i) an International Mobile Subscriber Identity number of said communication device, (ii) a Temporary Mobile Subscriber Identity, and (iii) a cellular telephone number of said communication device.

20. The method of claim 18, further comprising the steps of:
retrieving from said operator an operator password;
retrieving a previously stored operator password associated with said unique parameter of said first communication channel;
comparing said operator password and said previously stored operator password;
denying said request to make payment if said operator password and said previously stored operator password do not match;
retrieving from said payor a payor password;
retrieving a previously stored payor password associated with said unique parameter of said second communication channel;
comparing said payor password and said previously stored payor password; and
denying said request to make payment if said payor password and said previously stored payor password do not match.
